(19) United States
(12) Patent Application Publication
(10) Pub. No.: US 2023/0326666 A1
(43) Pub. Date: Oct. 12, 2023

(54) COIL COMPONENT

(71) Applicant: SAMSUNG ELECTRO-MECHANICS CO., LTD., Suwon-si (KR)

(72) Inventor: Jin Hyuk Jang, Suwon-si (KR)

(73) Assignee: SAMSUNG ELECTRO-MECHANICS CO., LTD., Suwon-si (KR)

(21) Appl. No.: 18/099,751

(22) Filed: Jan. 20, 2023

(30) Foreign Application Priority Data
Mar. 23, 2022 (KR) 10-2022-0036138

(51) Int. Cl. H01F 27/02; H01F 27/24; H01F 27/29

(52) U.S. Cl. CPC H01F 27/292; H01F 27/022; H01F 27/24

(57) ABSTRACT

A coil component includes a body having one surface and the other surface opposing each other in one direction, a coil portion disposed in the body, the coil portion including a lead-out portion, and an external electrode disposed on the one surface of the body to be connected to the lead-out portion. An outermost surface of the external electrode is disposed of inwards than the one surface of the body.

### CROSS-REFERENCE TO RELATED APPLICATION(S)

This application claims benefit of priority to Korean Patent Application No. 10-2022-0036138 filed on Mar. 23, 2022 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used together with a resistor and a capacitor in electronic devices.

As electronic devices are increasingly improved in performance while sizes thereof become smaller, the number of electronic components used in electronic devices has increased and the sizes of the electronic components have been reduced.

In order to achieve a coil component having high capacitance and high efficiency while having a reduced size, it is important to secure an effective volume.

### SUMMARY

An aspect of the present disclosure is to increase an effective volume of a body by reducing a volume of an electrode in a coil component so as to improve inductance characteristics.

Another aspect of the present disclosure is to provide a coil component with improved adhesive strength when mounted.

According to an aspect of the present disclosure, a coil component includes a body having one surface and the other surface opposing each other in one direction, a coil portion disposed in the body, the coil portion including a lead-out portion, and an external electrode disposed on the one surface of the body to be connected to the lead-out portion. An outermost surface of the external electrode is disposed of inwards than the one surface of the body.

According to another aspect of the present disclosure, a coil component includes a body having one surface and the other surface opposing each other in one direction, and a plurality of side surfaces connecting the one surface and the other surface, a coil portion disposed in the body, the coil portion including a lead-out portion extending to one side surface of the body, an external electrode disposed on the one side surface of the body to be connected to the lead-out portion, the external electrode covering at least a portion of the one surface of the body, and a first insulating layer disposed on the one surface of the body. A surface of the external electrode in contact with the one surface of the body is coplanar with a surface of the first insulating layer in contact with the one surface of the body. An outermost surface of the external electrode is disposed of inwards than an outermost surface of the first insulating layer.

According to another aspect of the present disclosure, a coil component includes a body, a coil portion disposed in the body and including a lead-out portion, and an external electrode connected to the lead-out portion. Opposing ends of the external electrode are embedded with respect to an outer surface of the coil component.

According an aspect of the present disclosure, an effective volume of a body may be increased by reducing a volume of an electrode in a coil component, thereby improving inductance characteristics, as compared to a component with the same size.

According another aspect of the present disclosure, adhesive strength may be improved when a coil component is mounted on a printed circuit board (PCB).

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to an example embodiment of the present disclosure;

FIG. 2 is a bottom perspective view of FIG. 1;

FIG. 3 is a view schematically illustrating a view from direction A of FIG. 1;

FIG. 4 is a bottom view schematically illustrating a view from direction B of FIG. 1;

FIG. 5 is a view illustrating a cross-section taken along line I-I′ of FIG. 1;

FIG. 6 is a bottom perspective view schematically illustrating a coil component according to a second example embodiment of the present disclosure;

FIG. 7 is a view illustrating a cross-section taken along line II-II′ of FIG. 6;

FIG. 8, which schematically illustrates a coil component according to a third example embodiment of the present disclosure, is a view corresponding to FIG. 6;

FIG. 9 is a view illustrating a cross-section taken along line III-III’ of FIG. 8;

FIG. 10, which schematically illustrates a coil component according to a fourth example embodiment of the present disclosure, is a view corresponding to FIG. 8;

FIG. 11 is a view illustrating a cross-section taken along line IV-IV′ of FIG. 10;

FIG. 12 is a perspective view schematically illustrating a coil component according to a fifth example embodiment of the present disclosure; and

FIG. 13 is a bottom perspective view of FIG. 12.

### DETAILED DESCRIPTION

The terms used in the description of the present disclosure are used to describe a specific example embodiment, and are not intended to limit the present disclosure. A singular term includes a plural form unless otherwise indicated. The terms “include,” “comprise,” “is configured to,” and the like of the description of the present disclosure are used to indicate the presence of features, numbers, steps, operations, elements, parts, or combination thereof, and do not exclude the possibilities of combination or addition of one or more additional features, numbers, steps, operations, elements, parts, or combination thereof. In addition, the terms “disposed on,” “positioned on,” and the like, may indicate that an element is positioned on or beneath an object, and does not necessarily mean that the element is positioned above the object with respect to a gravity direction.

The term “coupled to,” “combined to,” and the like, may not only indicate that elements are directly and physically in contact with each other, but also include a configuration in which another element is interposed between the elements such that the elements are also in contact with the other component.

Sizes and thicknesses of respective elements illustrated in the drawings are indicated as examples for ease of description, and the present disclosure are not limited thereto.

In the drawings, an L direction may be defined as a first direction or a length direction, a W direction may be defined as a second direction or a width direction, and a T direction may be defined as a third direction or a thickness direction.

Hereinafter, a coil component according to an example embodiment of the present disclosure is described in detail with reference to the accompanying drawings. Referring to the accompanying drawings, the same or corresponding components may be denoted by the same reference numerals, and repeated descriptions are omitted.

In electronic devices, various types of electronic components may be used, and various types of coil components may be properly used between the electronic components to remove noise, or for other purposes.

That is, in electronic devices, a coil component may be used as a power inductor, a high frequency (HF) inductor, a general bead, a high frequency (GHz) bead, a common mode filter, and the like.

### First Example Embodiment

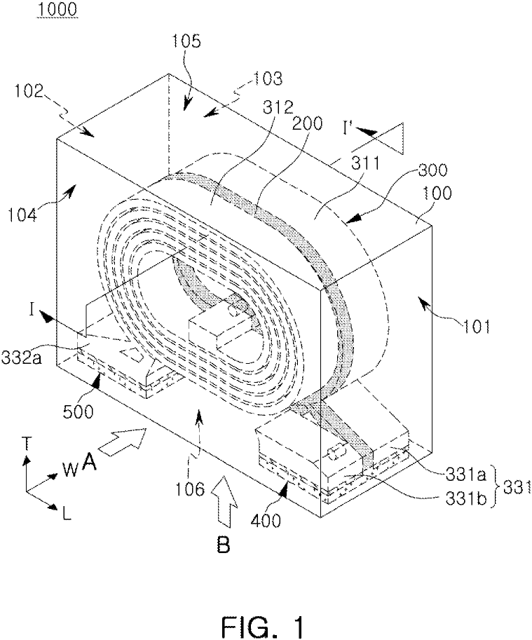

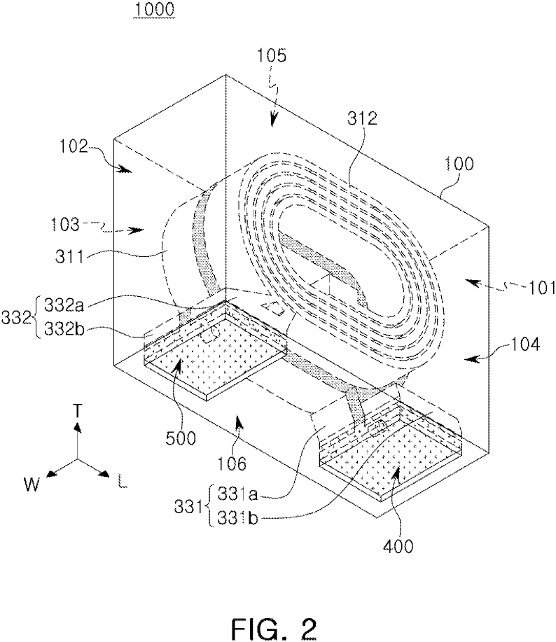

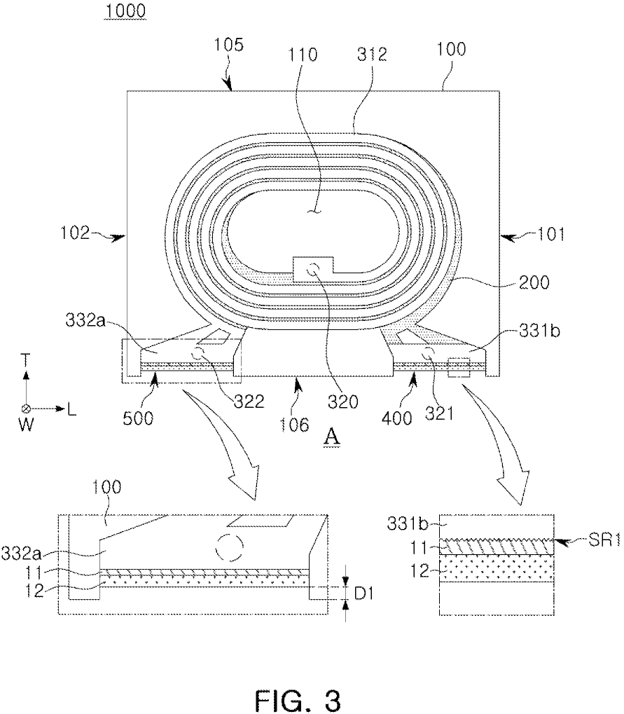

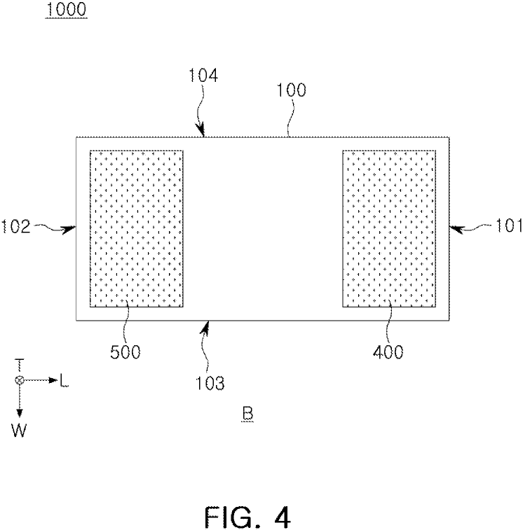

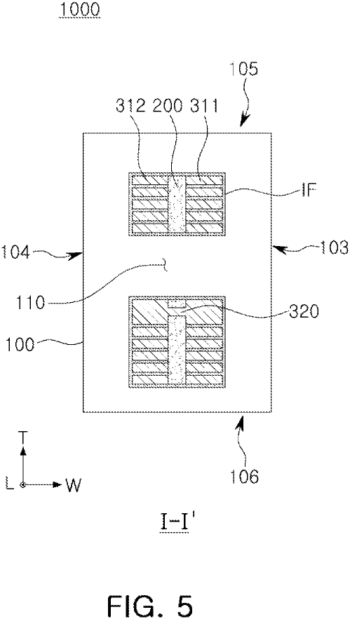

FIG. 1 is a perspective view schematically illustrating a coil component 1000 according to an example embodiment of the present disclosure. FIG. 2 is a bottom perspective view of FIG. 1. FIG. 3 is a view schematically illustrating a view from direction A of FIG. 1. FIG. 4 is a bottom view schematically illustrating a view from direction B of FIG. 1. FIG. 5 is a view illustrating a cross-section taken along line I-I′ of FIG. 1.

Referring to FIGS. 1 to 5, a coil component 1000 according to an example embodiment of the present disclosure may include a body 100, a coil portion 300, and external electrodes 400 and 500, and may further include a substrate 200 and/or an insulating layer IF.

The body 100 may form an exterior of the coil component 1000 according to the present example embodiment, and the coil portion 300 may be embedded therein.

The body 100 may be formed to have an overall hexahedral shape.

The body 100 may include a first surface 101 and a second surface 102 opposing each other in a longitudinal direction L, and a third surface 103 and a fourth surface 104 opposing each other in a width direction W, and a fifth surface 105 and a sixth surface 106 opposing in a thickness direction T. Each of the first to fourth surfaces 101, 102, 103, and 104 of the body 100 may correspond to a wall surface of the body 100 connecting the fifth surface 105 and the sixth surface 106 of the body 100.

The body 100 may be formed so that the coil component 1000 according to the present example embodiment in which to be described below are formed may be formed to have, for example, a length of 2.5 mm, a width of 2.0 mm, and a thickness of 1.0 mm, a length of 2.0 mm, a width of 1.2 mm, and a thickness of 0.65 mm, a length of 1.6 mm, a width of 0.8 mm, and a thickness of 0.8 mm, a length of 1.0 mm, a width of 0.5 mm, or a thickness of 0.8 mm, or a length of 0.8 mm, a width of 0.4 mm, a thickness of 0.65 mm, but the present embodiment is not limited thereto. The above-described exemplary numerical values for the length, width, and thickness of the coil component 1000 may refer to numerical values that do not reflect a process error, and thus it should be understood that numerical values in a range that is recognizable as a process error are the above-described exemplary numerical values.

The length of the above-described coil component 1000 may refer to, based on an optical microscope image or scanning electron microscope (SEM) image of a cross-section in a longitudinal direction L-thickness direction T taken from a central portion in a width direction W of the coil component 1000, a maximum value among dimensions of a plurality of line segments connecting two outermost boundary lines opposing to each other in a longitudinal direction L of the coil component 1000 illustrated in the image to be parallel to the longitudinal direction L, and spaced apart from each other in a thickness direction T. Alternatively, the length of the coil component 1000 may refer to a minimum value among the dimensions of the plurality of line segments described above. Alternatively, the length of the coil component 1000 may refer to an arithmetic mean value of at least three of the dimensions of the plurality of line segments described above. Here, the plurality of line segments parallel to the longitudinal direction L may be equally spaced apart from each other in the thickness direction T, but the scope of the present disclosure is not limited thereto.

The thickness of the above-described coil component 1000 may refer to, based on an optical microscope image or SEM image of a cross-section in a longitudinal direction L-thickness direction T taken from a central portion in a width direction W of the coil component 1000, a maximum value among dimensions of a plurality of line segments connecting two outermost boundary lines opposing to each other in a thickness direction T of the coil component 1000 illustrated in the image to be parallel to the thickness direction T, and spaced apart from each other in a longitudinal direction L. Alternatively, the thickness of the coil component 1000 may refer to a minimum value among the dimensions of the plurality of line segments described above. Alternatively, the thickness of the coil component 1000 may refer to an arithmetic mean value of at least three of the dimensions of the plurality of line segments described above. Here, the plurality of line segments parallel to the thickness direction T may be equally spaced apart from each other in the longitudinal direction L, but the scope of the present disclosure is not limited thereto.

The width of the above-described coil component 1000 may refer to, based on an optical microscope image or SEM image of a cross-section in a longitudinal direction L-width direction W taken from a central portion in a thickness direction T of the coil component 1000, a maximum value among dimensions of a plurality of line segments connecting two outermost boundary lines opposing to each other in a width direction T of the coil component 1000 illustrated in the image to be parallel to the width direction W, and spaced apart from each other in a longitudinal direction L. Alternatively, the width of the coil component 1000 may refer to a minimum value among the dimensions of the plurality of line segments described above. Alternatively, the width of the coil component 1000 may refer to an arithmetic mean value of at least three of the dimensions of the plurality of line segments described above. Here, the plurality of line segments parallel to the width direction W may be equally spaced apart from each other in the longitudinal direction L, but the scope of the present disclosure is not limited thereto.

Alternatively, each of the length, width, and thickness of the coil component 1000 may be measured by a micrometer mensuration. According to the micrometer mensuration, measurement may be performed by setting a zero point with a gage repeatability and reproducibility (R&R) micrometer, inserting the coil component 1000 according to the present example embodiment between micrometer tips, and turning a micrometer measuring lever. In measuring the length of the coil component 1000 using the micrometer mensuration, the length of the coil component 1000 may refer to a value measured once or an arithmetic average of values measured a plurality of times, which may be equally applied to the width and thickness of the coil component 1000.

The body 100 may include a magnetic material and a resin. Specifically, the body 100 may be formed by stacking at least one composite sheet including magnetic materials dispersed in the resin. However, the body 100 may have a structure other than the structure in which the magnetic materials are dispersed in the resin. For example, the body 100 may be made of a magnetic material such as ferrite, or may be made of a non-magnetic material.

The magnetic powder may be, for example, a ferrite powder or a magnetic metal powder.

The ferrite may include, for example, at least one of spinel type ferrites such as Mg-Zn-based ferrite, Mn-Zn-based ferrite, Mn-Mg-based ferrite, Cu-Zn-based ferrite, Mg-Mn-Sr-based ferrite, Ni-Zn-based ferrite, and the like, hexagonal ferrites such as Ba-Zn-based ferrite, Ba-Mg-based ferrite, Ba-Ni-based ferrite, Ba-Co-based ferrite, Ba-Ni-Co-based ferrite, and the like, garnet type ferrites such as Y-based ferrite, and the like, and Li-based ferrites.

The magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be at least one of a pure iron powder, an Fe-Si-based alloy powder, an Fe-Si-Al-based alloy powder, an Fe-Ni-based alloy powder, an Fe-Ni-Mo-based alloy powder, an Fe-Ni-Mo-Cu-based alloy powder, an Fe-Co-based alloy powder, an Fe-Ni-Co-based alloy powder, an Fe-Cr-based alloy powder, an Fe-Cr-Si-based alloy powder, an Fe-Si-Cu-Nb-based alloy powder, an Fe-Ni-Cr-based alloy powder, and an Fe-Cr-Al-based alloy powder.

The magnetic metal powder may be amorphous or crystalline. For example, the magnetic metal powder may be an Fe-Si-B-Cr-based amorphous alloy powder, but the present embodiment is not limited thereto.

The ferrite powder and the magnetic metal powder may have an average diameter of about 0.1 µm to 30 µm, respectively, but the present embodiment is not limited thereto.

The body 100 may include two or more types of magnetic materials dispersed in a resin. Here, different types of magnetic materials may mean that magnetic materials dispersed in a resin is distinguished from each other by one of an average diameter, a composition, crystallinity, and a shape.

The resin may include an epoxy, a polyimide, a liquid crystal polymer, and the like in a single form or in a combined form, but the present embodiment is not limited thereto.

The body 100 may include a core 110 passing through a substrate 200 to be described below and the coil portion 300. The core 110 may be formed by filling a through-hole of the coil portion 300 with a magnetic composite sheet, but the present embodiment is not limited thereto.

The substrate 200 may be disposed in the body 100. The substrate 200 may be configured to support the coil portion 300 to be described below. The coil portion 1000 according to the present example embodiment may be disposed on the substrate 200 to be perpendicular to the sixth surface 106 that is a mounting surface, but the present embodiment is not limited thereto.

The substrate 200 may be formed of an insulating material including a thermosetting insulating resin such as an epoxy resin, a thermoplastic insulating resin such as polyimide, or a photosensitive insulating resin, or may be formed of an insulating material in which a reinforcing material such as a glass fiber or an inorganic filler is impregnated with the insulating resin. For example, the substrate 200 may include a prepreg, Ajinomoto build-up film (ABF), FR-4, bismaleimide triazine (BT) resin, photoimageable dielectric (PID), copper clad laminate (CCL), and the like, but the present embodiment is not limited thereto.

As the inorganic filler, at least one selected from a group consisting of silica (SiO₂), alumina (Al₂O₃), silicon carbide (SiC), barium sulfate (BaSO₄), talc, mud, a mica powder, aluminum hydroxide (Al(OH)₃), magnesium hydroxide (Mg (OH) ₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

When the substrate 200 is formed of an insulating material including a reinforcing material, the substrate 200 provide more excellent rigidity. When the substrate 200 is formed of an insulating material including no glass fibers, it may be advantageous in reducing a width of a component by thinning an overall thickness of the substrate 200 and the coil portion 300 (where the overall thickness refers to a sum of dimensions of the coil portion 300 and the substrate 200 in the width direction W of FIG. 1). When the substrate 200 is formed of an insulating material including a photosensitive insulating resin, the number of processes for forming the coil portion 300 may be reduced. Accordingly, it may be advantageous in reducing production costs, and a fine via may be formed. The thickness of the substrate 200 may be, for example, 10 µm or more and 50 µm or less, but the present embodiment is not limited thereto.

The coil portion 300 may be disposed in the body 100. The coil portion 300 may be embedded in the body 100 to manifest characteristics of a coil component. For example, when the coil component 1000 according to the present example embodiment is used as a power inductor, the coil portion 300 may function to stabilize the power supply of an electronic device by storing an electric field as a magnetic field and maintaining an output voltage.

The coil portion 300 may include coil patterns 311 and 312, a via 320, and lead-out portions 331 and 332. In addition, the lead-out portions 331 and 332 may include lead-out patterns 331a and 332a, sub-lead-out patterns 331b and 332b, and sub-vias 321 and 322 respectively connecting the lead-out patterns 331a and 332a and the sub-lead-out patterns 331b and 332b.

In the present example embodiment, the coil patterns 311 and 312 of the coil portion 300 may be disposed to be perpendicular to the sixth surface 106 of the body 100 that is a mounting surface, thereby reducing a mounting area while maintaining volumes of the body 100 and the coil portion 300. Thus, a larger number of electronic components may be mounted on a mounting board with the same area. In addition, in the present example embodiment, the coil patterns 311 and 312 of the coil portion 300 may be disposed to be perpendicular to the sixth surface 106 of the body 100 that is the mounting surface, and thus a direction of a magnetic flux induced to the core 110 may be disposed to be parallel to the sixth surface 106 of the body 100. Thus, noise induced to a mounting surface of a mounting substrate may be relatively reduced.

In the present example embodiment, the coil patterns 311 and 312 of the coil portion 300 disposed to be perpendicular to the sixth surface 106 of the body 100 that is the mounting surface may mean that, as illustrated in FIG. 1, an angle formed by the coil patterns 311 and 312 with the sixth surface 106 of the body 100 when surfaces of the first and second coil patterns 311 and 312 in contact with the substrate 200 virtually extend is vertical or close to the vertical. For example, the first and second coil patterns 311 and 312 or the substrate 200 supporting the first and second coil patterns 311 and 312 may form an angle of 80° to 100° with the sixth surface 106 of the body 100.

Referring to FIGS. 3 and 5, the coil portion 300 may include first and second coil patterns 311 and 312 having a plurality of turns, a via 320 passing through the substrate 200 to connect inner ends of the first and second coil patterns 311 and 312 to each other, and first and second lead-out portions 331 and 332 exposed to the sixth surface 106 of the body 100 and spaced apart from each other.

In addition, the lead-out portions 331 and 332 may include lead-out patterns 331a and 332a connected to the coil patterns 311 and 312, sub-lead-out patterns 331b and 332b spaced apart from the coil patterns 311 and 312, and sub-vias 321 and 322 respectively connecting the lead-out patterns 331a and 332a and the sub-lead-out patterns 331b and 332b.

Referring to FIG. 3, the lead-out patterns 331a and 332a and the sub-lead-out patterns 331b and 332b forming the lead-out portions 331 and 332 may be formed further inwards than the sixth surface 106 of the body 100. That is, surfaces of the lead-out portions 331 and 332 exposed to the sixth surface 106 of the body 100 may be recessed inwardly by an etching process to form a step difference. The etching process may be dry etching or wet etching, but is not particularly limited.

Here, a depth to which the lead-out portions 331 and 332 are recessed may be formed so that outermost surfaces of the external electrodes 400 and 500 have, with respect to a thickness direction T, a predetermined depth D1 further inwards than the sixth surface 106 of the body 100 in a state in which the external electrodes 400 and 500 to be described below are disposed on the lead-out portions 331 and 332. For example, opposing ends of the first external electrode 400 and opposing ends of the second external electrode 500 may be embedded with respect to an outer surface of the coil component such as the sixth surface 106 of the body 100.

The lead-out portions 331 and 332 may be generally formed on the same planar surface as the sixth surface 106 of the body 100 by a dicing process. As the etching process is added, the coil component 1000 according to the present example embodiment may not further protrude than the sixth surface 106 of the body 100 even after the external electrodes 400 and 500 to be described below are disposed on the lead-out portions 331 and 332. Through such a structure, it is possible to have effects such as miniaturization of components, improvement of effective volume, and improvement of adhesive strength when mounted.

In addition, referring to FIG. 3, according to the etching process performed on the surfaces of the lead-out portions 331 and 332, a surface roughness SR1 of each of the surfaces of the lead-out portions 331 and 332 in direct contact with a first metal layer 11 of the external electrodes 400 and 500 may be formed to be different from (or higher than) a surface roughness of each of outermost surfaces of the external electrodes 400 and 500, that is, an outermost surface of a second metal layer 12.

Referring to FIGS. 3 and 4, when the lead-out portions 331 and 332 are exposed to the sixth surface 106 of the body 100, the lead-out portions 331 and 332 may be spaced apart from the first to fourth surfaces 101, 102, 103, and 104 of the body 100, respectively.

Through such a structure, when the external electrodes 400 and 500 to be described below are disposed on the lead-out portions 331 and 332, the external electrodes 400 and 500 may also be formed to be spaced apart from the first to fourth surfaces 101, 102, 103, and 104 of the body 100, respectively.

As described above, the coil component 1000 having the external electrodes 400 and 500 respectively spaced apart from the first to fourth surfaces 101, 102, 103, and 104 of the body 100 may have a reduced risk of a short circuit with adjacent components when mounted, and thus may have an effect of improving a degree of integration.

Referring to FIGS. 1 and 5, the first coil pattern 311 and the second coil pattern 312 of the coil portion 300 may be respectively disposed on opposite surfaces of the substrate 200 opposing each other to have a planar spiral shape with at least one turn formed with respect to the core 110 of the body 100. For example, with respect to the direction of FIG. 1, the first coil pattern 311 may be disposed on a rear surface of the substrate 200 to form at least one turn with respect to the core 110. The second coil pattern 312 may be disposed on a front surface of the substrate 200 to form at least one turn with respect to the core 110. Each of the first and second coil patterns 311 and 312 may be formed to have a shape of an end of an outermost turn connected to the lead-out portions 331 and 332 extending toward the sixth surface 106 of the body 100 from a central portion in the thickness direction T of the body 100. That is, a region in which the end of the outermost turn of each of the first and second coil patterns 311 and 312 and the lead-out portions 331 and 332 are connected to each other may be disposed closer to the sixth surface 106 than the fifth surface 105 of the body 100. As a result, the first and second coil patterns 311 and 322 may increase a total number of turns of the coil portion 300 when compared to a case in which an end of an outermost turn of a coil is formed only up to on the central portion in the thickness direction T of the body 100.

Referring to FIG. 5, the via 320 may pass through the substrate 200 to connect inner ends of innermost turns of the first and second coil patterns 311 and 312 to each other.

Referring to FIGS. 1 to 3, the lead-out patterns 331a and 332a and the sub-lead-out patterns 331b and 332b included in the lead-out portions 331 and 332 may be exposed to be spaced apart from each other on the sixth surface 106 of the body 100. In addition, the lead-out patterns 331a and 332a and the sub-lead-out patterns 331b and 332b may be disposed to be spaced apart from the first to fourth surfaces 101, 102, 103, and 104 of the body 100. That is, the coil component 1000 according to the present example embodiment may have a structure in which the lead-out patterns 331a and 332a and the sub-lead-out patterns 331b and 332b are exposed only to the sixth surface 106 of the body 100, that is, the mounting surface, but the present embodiment is not limited thereto.

Specifically, referring to FIGS. 1 to 3, the first lead-out portion 331 may include a first lead-out pattern 331a connected to the first coil pattern 311, a first sub-lead-out pattern 331b spaced apart from the first coil pattern 311, and a first sub-via 321 connecting the first lead-out pattern 331a and the first sub-lead-out pattern 331b.

In addition, the second lead-out portion 332 may include a second lead-out pattern 332a connected to the second coil pattern 312, a second sub-lead-out pattern 332b spaced apart from the second coil pattern 312, and a second sub-via 322 connecting the second lead-out pattern 332a and the second sub-lead-out pattern 332b to each other.

The first lead-out pattern 331a may extend from the first coil pattern 311 on the rear surface of the substrate 200 to be exposed to the sixth surface 106 of the body 100, and the first sub-lead-out pattern 331b, which has a shape corresponding to that of the first lead-out pattern 331a at a position corresponding to that of the first lead-out pattern 331a on the front surface of the substrate 200, may be disposed to be spaced apart from the second coil pattern 312.

In addition, the second lead-out pattern 332a may extends from the second coil pattern 312 on the front surface of the substrate 200 to be exposed to the sixth surface 106 of the body 100, and the second sub-lead-out pattern 332b, which has a shape corresponding to that of the second lead-out portion 332 at a position corresponding to that of the second lead-out portion 332 on the rear surface of the substrate 200, may be disposed to be spaced apart from the first coil pattern 311.

Referring to FIG. 2, the first lead-out pattern 331a and the first sub-lead-out pattern 331b, and the second lead-out pattern 332a and the second sub-lead-out pattern 332b may be exposed to the sixth surface of the body 100 to be spaced apart from each other, respectively, and may be connected in contact with first and second external electrodes 400 and 500 to be described below, respectively.

The lead-out patterns 331a and 332a and the sub-lead-out patterns 331b and 332b may be interconnected by sub-vias 321 and 322 passing through the substrate 200.

The first sub-via 321 may pass through the substrate 200 to connect the first lead-out pattern 331a and the first sub-lead-out pattern 331b to each other. The second sub-via 322 may pass through the substrate 200 to connect the second lead-out pattern 332a and the second sub-lead-out pattern 332b to each other. Thus, the coil portion 300 may function as a single coil connected as a whole.

Cross-sectional areas of the lead-out patterns 331a and 332a exposed to the sixth surface 106 of the body 100 and cross-sectional areas of the sub-lead-out patterns 331b and 332b exposed to the sixth surface 106 of the body 100 may be substantially the same, thereby securing reliability of a connection between the external electrodes 400 and 500 be described below and the coil portion 300, and preventing warpage of the substrate 200 due to the external electrodes 400 and 500 that are symmetrically formed.

The sub-lead-out patterns 331b and 332b may not be key components for electrical connection between the coil portion 300 and the external electrodes 400 and 500 to be described below, and thus it should be noted that a case in which first and second sub-vias 321 and 322 are omitted is also included in the scope of the present disclosure.

However, in the same manner as the present example embodiment, when the lead-out patterns 331a and 332a and the sub-lead-out patterns 331b and 332b are respectively connected through the first and second sub-vias 321 and 322, the reliability of the connection between the coil portion 300 and the external electrodes 400 and 500 may be improved, and the sub-lead-out patterns 331b and 332b may also be electrically connected to the external electrodes 400 and 500 and the coil patterns 311 and 312, and thus an Rdc characteristic may be improved by securing an electrode surface.

At least one of the coil patterns 311 and 312, the via 320, the lead-out patterns 331a and 332a, the sub-lead-out patterns 331b and 332b, and the sub-vias 321 and 322 may include at least one conductive layer.

For example, the coil patterns 311 and 312, the via 320, the lead-out patterns 331a and 332a, sub-lead-out patterns 331b and 332b, and sub-vias 321 and 322 are formed on the substrate 200 (with respect to the direction in FIG. 1) by a plating process, each of the first coil pattern 311, the via 320, the first lead-out pattern 331a, the second sub-lead-out pattern 332b, and the sub-vias 321 and 322 may include a seed layer and an electroplating layer. The seed layer may be formed by a vapor deposition process such as electroless plating or sputtering. Each of the seed layer and the electroplating layer may have a single-layer structure or a multi-layer structure. The electrolytic plating layer having the multi-layer structure may be formed to have a conformal film structure in which one electroplating layer is covered by another electroplating layer, and to have a shape in which one electroplating layer is stacked on only one surface of another electroplating layer. The seed layer of the first coil pattern 311, the seed layer of the via 320, the seed layer of the first lead-out pattern 331a, and the seed layer of the first sub-via 321 may be integrally formed to form no boundary therebetween, but the present embodiment is not limited thereto. The seed layer of the first coil pattern 311, the seed layer of the via 320, the seed layer of the first lead-out pattern 331a, and the electrolytic plating layer of the first sub-via 321 may be integrally formed to form no boundary therebetween, but the present embodiment is not limited thereto.

Each of the coil patterns 311 and 312, the via 320, the lead-out patterns 331a and 332a, the sub-lead-out patterns 331b and 332b, and the sub-vias 321 and 322 may include a conductive material such as copper (Cu), aluminum (Al), silver (Ag), tin (Sn), gold (Au), nickel (Ni), lead (Pb), titanium (Ti), chromium (Cr), molybdenum (Mo), alloys thereof, or the like, but the present embodiment is not limited thereto.

In the case that the coil component 1000 according to the present example embodiment is mounted on a printed circuit board (PCB) or like, the external electrodes 400 and 500 may electrically connect the coil component 1000 to the PCB or the like. For example, as the coil component 1000 according to the present example embodiment is mounted so that the sixth surface 106 of the body 100 faces an upper surface of the PCB, the external electrodes 400 and 500 spaced apart from each other on the sixth surface 106 of the body 100 may be electrically connected to a connection portion of the PCB.

Referring to FIGS. 2 to 4, the external electrodes 400 and 500 may be spaced apart from each other on the sixth surface 106 of the body 100 to be connected to the first and second lead-out portions 331 and 332, respectively.

Specifically, the first external electrode 400 may be disposed on the sixth surface 106 of the body 100 to be connected in contact with the first lead-out pattern 331a and the first sub-lead-out pattern 331b. In addition, the second external electrode 500 may be disposed to be spaced apart from the first external electrode 400 on the sixth surface 106 of the body 100 to be connected in contact with the second lead-out pattern 332a and a second sub-lead-out pattern 332b.

Referring to FIG. 3, outermost surfaces of the external electrodes 400 and 500 may be formed, with respect to the thickness direction T, further inwards than the sixth surface 106 of the body 100.

A step difference may be formed inside the body 100 through an etching process performed on surfaces of the lead-out portions 331 and 332 on which the external electrodes 400 and 500 are disposed, and a step difference between outermost surfaces of the lead-out portions 331 and 332 may be formed to be greater than a thickness at which the external electrodes 400 and 500 are formed, and thus the outermost surfaces of the external electrodes 400 and 500 may be formed further inwards, by a predetermined depth D1, than the sixth surface 106 of the body 100.

Through such an electrode-embedded structure, a volume occupied by a magnetic material of the body 100 in a coil component with the same size may be increased, thereby having an effect of improving an effective volume. In addition, compared to an electrode protrusion type structure, adhesive strength when mounted may also be improved.

TABLE 1

| Experimental Example | Electrode embedment depth (um) | External electrode thickness (um) | Minimum value of adhesive strength (N) | Average value of adhesive strength (N) |
|---|---|---|---|---|
| #1 | -10 (Protrusion) | 10 | 0.94 | 1.27 |
| #2 | 0 (Same surface) | 10 | 1.03 | 1.31 |
| #3 | | 15 | 1.14 | 1.44 |
| #4 | | 20 | 1.20 | 1.61 |
| #5 | 5 | 10 | 1.12 | 1.50 |
| #6 | | 15 | 1.33 | 1.87 |
| #7 | | 20 | 1.50 | 2.19 |
| #8 | 10 | 10 | 1.31 | 1.87 |
| #9 | | 15 | 1.51 | 2.14 |
| #10 | | 20 | 1.69 | 2.38 |

Referring to Table 1, it can be seen that adhesive strength of the external electrodes 400 and 500 is greater in Experimental Examples #5 to #10 in which the external electrodes 400 and 500 form a step difference inside to be embedded, compared to Experimental Example #1 in which the external electrodes 400 and 500 protrude, and Experimental Examples #2 to #4 in which the external electrodes 400 and 500 form the same planar surface as a surface of the body 100.

Referring to FIG. 4, in the coil component 1000 according to the present example embodiment, the external electrodes 400 and 500 may be formed to be spaced apart from the first to fourth surfaces 101, 102, 103, and 104 of the body 100. Through such a structure, it is possible to reduce a risk of a short circuit with an adjacent component when mounted, thereby having an effect of being advantageous for miniaturization and integration.

Referring to FIG. 3, a surface roughness of each of the outermost surfaces of the lead-out portions 331 and 332 may be changed by an etching process for forming a step difference between the lead-out portions 331 and 332. That is, a surface roughness SR1 of each of surfaces of the lead-out portions 331 and 332 in contact with the external electrodes 400 and 500 may be different from (or higher than) a surface roughness of each of outermost surfaces of the external electrodes 400 and 500, but the present embodiment is not limited thereto.

The substrate 200 may be disposed between the lead-out patterns 331a and 332b and the sub-lead-out patterns 331b and 332b to be exposed to the sixth surface 106 of the body 100. In this case, a recess may be formed due to plating deviation in regions of the external electrodes 400 and 500 corresponding to the substrate 200 exposed to the sixth surface 106 of the body 100, but the present embodiment is not limited thereto.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), alloys thereof, or the like, but the present embodiment is not limited thereto.

Each of the external electrodes 400 and 500 may be formed of a plurality of layers. For example, the first external electrode 400 may include a first metal layer 11 in contact with the first lead-out portion 331, and a second metal layer 12 disposed on the first metal layer 11.

An outermost surface of the second metal layer 12 may be formed further inwards, by a predetermined depth D1, than the sixth surface 106 of the body 100, and a surface roughness between the first metal layer 11 and the lead-out portions 331 and 332 may be formed to be different from (or higher than) a surface roughness between the first metal layer 11 and the second metal layer 12 or a surface roughness of the outermost surface of the second metal layer 12.

Here, the first metal layer 11 may be a plating layer including nickel (Ni), and the second metal layer 12 may be a plating layer including tin (Sn), but the present embodiment is not limited thereto.

Referring to FIG. 5, the coil component 1000 according to the present example embodiment may further include an insulating film IF disposed in the body 100 to surround the coil portion 300.

The insulating film IF may be disposed between the coil portion 300 and the body 100 to cover the coil portion 300. The insulating layer IF may be formed along surfaces of the substrate 200 and the coil portion 300. The insulating layer IF, which is used to insulate the coil portion 300 from the body 100, may include a known insulating material such as parylene or the like, but the present embodiment is not limited thereto. The insulating film IF may be formed using a vapor deposition process or the like, but the present embodiment is not limited thereto, and may be formed by stacking an insulation film on opposite surfaces of the substrate 200.

Although not illustrated, in the present example embodiment, an insulating layer may be further included to cover the first to sixth surfaces 101, 102, 103, 104, 105, and 106 of the body 100, and the insulating layer may expose each of the external electrodes 400 and 500 may be further included. The insulating layer may be formed by, for example, by coating and curing an insulating material including an insulating resin on a surface of the body 100. In this case, a surface insulating layer may include at least one of a thermoplastic resin such as a polystyrene resin, a vinyl acetate resin, a polyester resin, a polyethylene resin, a polypropylene resin, a polyamide resin, a rubber resin, an acrylic resin, or the like, a thermosetting resin such as a phenolic resin, an epoxy resin, a urethane resin, a melamine resin, an alkyd resin, or the like, and a photosensitive resin.

### Second Example Embodiment

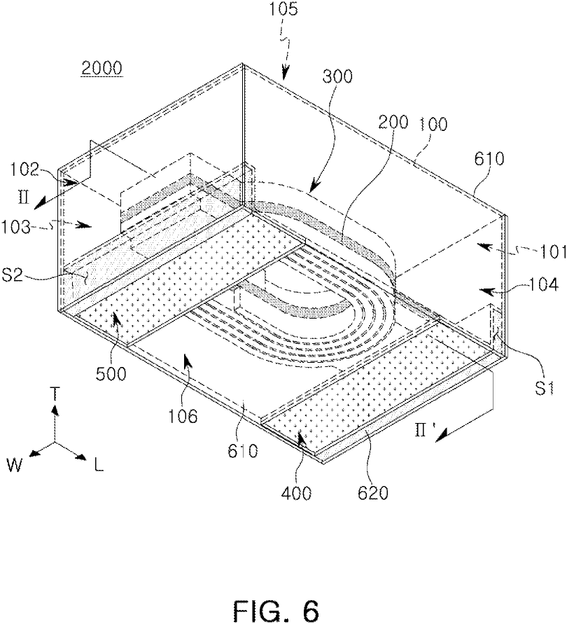

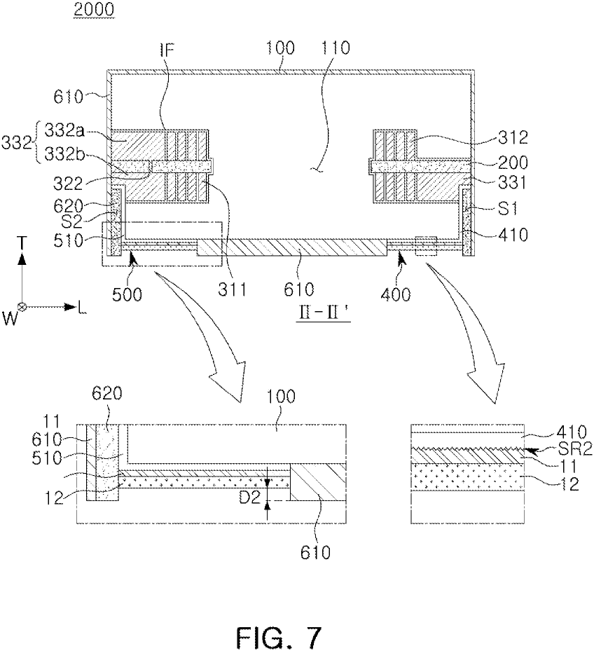

FIG. 6 is a bottom perspective view schematically illustrating a coil component according to a second example embodiment of the present disclosure. FIG. 7 is a view illustrating a cross-section taken along line II-II′ of FIG. 6.

When comparing FIGS. 2 and 3 with FIGS. 6 and 7, respectively, a coil component 2000 according to the second example embodiment of the present disclosure may be different from the coil component 1000 according to the first example embodiment of the present disclosure in that slit portions S1 and S2 are formed in the body 100, a direction of a central axis of each turn of the coil patterns 311 and 312 is the thickness direction T, and the external electrodes 400 and 500 further include connection portions 410 and 510.

Therefore, in describing the present example embodiment, only the slit portions S1 and S2, the coil patterns 311 and 312, and the connection portions 410 and 510, which are different from those in the first example embodiment of the present disclosure, are described. With respect to the other elements of the present example embodiment, the description of the first example embodiment of the present disclosure may be applied in the same manner.

In the coil component 2000 according to the present example embodiment, the slit portions S1 and S2 may be formed in the body 100.

Referring to FIGS. 6 and 7, the slit portions S1 and S2 may be formed at an edge portion of the sixth surface 106 of the body 100. Specifically, the slit portions S1 and S2 may be formed along an edge portion between the first and second surfaces 101 and 102 of the body 100 and the sixth surface 106 of the body 100, respectively. That is, the first slit portion S1 may be formed along an edge portion between the first surface 101 of the body 100 and the sixth surface 106 of the body 100, and the second slit portion S2 may be formed along an edge portion between the second surface 102 of the body 100 and the sixth surface 106 of the body 100. The slit portions S1 and S2 may have a shape of extending from the third surface 103 to the fourth surface 104 of the body 100. The slit portions S1 and S2 may not extend to the fifth surface 105 of the body 100. That is, the slit portions S1 and S2 do not pass through the body 100 in the thickness direction T thereof.

The slit portions S1 and S2 may be formed by performing a pre-dicing process on one surface of a coil bar along a virtual boundary corresponding to a width direction of a coil component among virtual boundaries for dividing the coil bar into coil components on a level of the coil bar, a state before dividing the coil bar into coil components. In the pre-dicing process, a depth may be adjusted to expose lead-out portions 231 and 232 to inner surfaces of the slit portions S1 and S2. Each of the inner surfaces of the slit portions S1 and S2 may have an inner wall substantially parallel to the first and second surfaces 101 and 102 of the body 100, and a lower surface connecting the inner wall to the first and second surfaces 101 and 102 of the body 100.

Each of the inner surfaces of the slit portions S1 and S2 may also correspond to a surface of the body 100. However, in the present specification, for better understanding of the present disclosure and ease of description, the inner surfaces of the slit portions S1 and S2 may be distinguished from the first to sixth surfaces 101, 102, 103, 104, 105, and 106, which are surfaces of the body 100.

Referring to FIGS. 6 and 7, in the coil component 2000 according to the present example embodiment, the central axis of each turn of the coil patterns 311 and 312 may be formed in parallel with the thickness direction T.

The lead-out portions 331 and 332 may be formed to be exposed to the first surface 100, the second surface 102, and the slit portions S1 and S2 of the body 100.

The first lead-out portion 331 may be exposed to each of the first surface 101 of the body 100 and the inner surface of the first slit portion S1. The first lead-out portion 331 may be continuously exposed to the first surface 101 of the body 100, a bottom surface of the first slit portion S1, and the inner wall of the first slit portion S1.

The second lead-out portion 332 may be exposed to each of the second surface 102 of the body 100 and the inner surface of the second slit portion S2. The second lead-out portion 332 may be continuously exposed to the second surface 102 of the body 100, a bottom surface of the second slit portion S2, and the inner wall of the second slit portion S2.

In the present example embodiment, the second lead-out portion 332 may include the second lead-out pattern 332a, the second sub-lead-out pattern 332b, and the second sub-via 322 connecting the second lead-out pattern 332a and the second sub-lead-out pattern 332b to each other.

Referring to FIG. 7, on an upper surface of the substrate 200, the second coil pattern 312 may be connected in contact with the second lead-out pattern 332a, and the second lead-out pattern 332a may be connected to the second sub-lead-out pattern 332b through the second sub-via 322 passing through the substrate 200.

In addition, on a lower surface of the substrate 200, the first coil pattern 311 may be connected in contact with the first lead-out portion 331, and may be disposed to be spaced apart from the second sub-lead-out pattern 332b.

Here, the inner ends of the first and second coil patterns 311 and 312 may be connected to each other through the via 320 passing through the substrate 200, the first lead-out portion 331 may be connected to the first external electrode 400, and the second sub-lead-out pattern 332b may be connected to the second external electrode 500.

As a result, when an input into the first external electrode 400 is made, the input may be output to the second external electrode 500 through the first lead-out portion 331, the first coil pattern 311, the via 320, the second coil pattern 312, and the second lead-out portion 332, and thus, the coil portion 300 may function as a single coil as a whole.

In more detail, the input may sequentially pass through the first lead-out portion 331, the first coil pattern 311, the via 320, the second coil pattern 312, the second lead-out pattern 332a, and the second sub-via 322 to be output to the second external electrode 500.

Referring to FIGS. 6 and 7, the external electrodes 400 and 500 may further include connection portions 410 and 510 connected to the lead-out portions 331 and 332.

The connection portions 410 and 510 may be a conductive resin layer including a conductive powder including at least one of copper (Cu) and silver (Ag), and an insulating resin, or a copper (Cu) plating layer.

The first connection portion 410 may be connected in contact with the first lead-out portion 331 in the first slit portion S1 to extend to the sixth surface 106 of the body 100. In addition, the second connection portion 510 may be connected in contact with the second lead-out portion 332, more specifically, the second sub-lead-out pattern 332b in the second slit portion S2 to extend to the sixth surface 10 of the body 100.

In the coil component 2000 according to the present example embodiment, the first metal layer 11 and the second metal layer 12 may be sequentially disposed on lower surfaces of the connection portions 410 and 510. Here, the first metal layer 11 may be a plating layer including nickel (Ni), and the second metal layer 12 may be a plating layer including tin (Sn), but the present embodiment is not limited thereto.

Referring to FIG. 7, the first insulating layer 610 may be disposed on the sixth surface 106 of the body 100. Here, the first insulating layer 610 may be formed in a region in which the external electrodes 400 and 500 are not to be disposed on the sixth surface 106 of the body 100 to function as a plating resist, but the present embodiment is not limited thereto.

Each of surfaces of the external electrodes 400 and 500 in contact with the sixth surface 106 of the body 100 may be coplanar with a surface of the first insulating layer 610 in contact with the sixth surface 106 of the body 100. That is, each of the surfaces of the external electrodes 400 and 500 in contact with the sixth surface 106 of the body 100 may form substantially the same planar surface as the surface of the first insulating layer 610 in contact with the sixth surface 106 of the body 100. Here, substantially the same may refer to the same, including a process error or positional deviation occurring during a manufacturing process, and an error during measurement.

In the coil component 2000 according to the present example embodiment, outermost surfaces of the external electrodes 400 and 500 may be formed, with respect to the thickness direction T, further inwards by a predetermined depth D2 than an outermost surface of the first insulating layer 610 formed on the sixth surface 106 of the body 100. For example, opposing ends of the first external electrode 400 and opposing ends of the second external electrode 500 may be embedded with respect to an outer surface of the coil component such as an outer surface of the first insulating layer 610 and an outer surface of a second insulating layer 620 to be described below.

This may be a structure formed through an etching process performed on the lower surfaces of the connection portions 410 and 510, and accordingly, a surface roughness SR2 of a surface of the first metal layer 11 in contact with the connection portions 410 and 510 may be formed to be different from (or higher than) a surface roughness of each of outermost surfaces of the external electrode 400 and 500.

Through such an electrode-embedded structure, a volume occupied by a magnetic material of the body 100 in a coil component with the same size may be increased, thereby having an effect of improving an effective volume. In addition, compared to an electrode protrusion type structure, adhesive strength when mounted may also be improved.

The first insulating layer 610 may also be disposed on the first to fifth surfaces 101, 102, 103, 104, and 105 of the body 100, and a second insulating layer 620 to be described below may be covered by the slit portions S1 and S2.

Referring to FIGS. 6 and 7, the coil component 2000 according to the present example embodiment may further include the second insulating layer 620 covering the external electrodes 400 and 500 in the slit portions S1 and S2.

The second insulating layer 620 may cover the connection portions 410 and 510 disposed along shapes of the slit portions S1 and S2, and may be formed by a process such as a printing process, a vapor deposition process, a spray application process, a film stacking process, or the like, but the present embodiment is not limited thereto.

The second insulating layer 620 may include a thermoplastic resin such as a polystyrene resin, a vinyl acetate resin, a polyester resin, a polyethylene resin, a polypropylene resin, a polyamide resin, a rubber resin, an acrylic resin, or the like, a thermosetting resin such as a phenolic resin, an epoxy resin, a urethane resin, a melamine resin, an alkyd resin, or the like, a photosensitive resin, parylene, SiOₓ, or SiNₓ, but the present embodiment is not limited thereto.

The coil component 2000 according to the present example embodiment may adjust insulation margins of the external electrodes 400 and 500 by adjusting a thickness of the second insulating layer 620, and accordingly may have an effect of reducing a short circuit defect between adjacent components.

### Third Example Embodiment

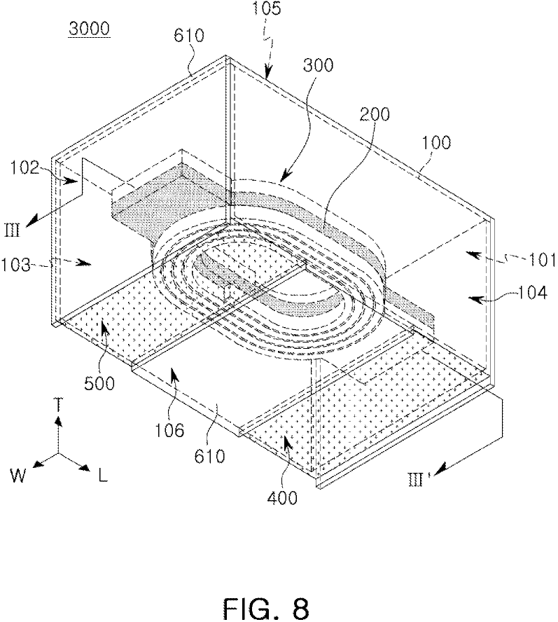

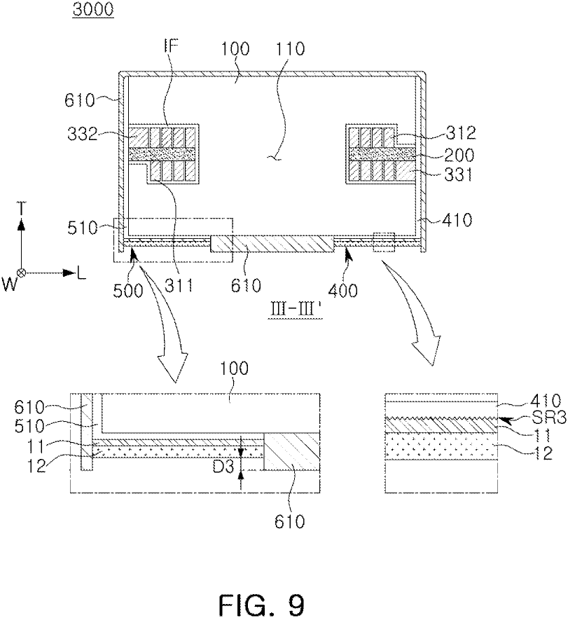

FIG. 8, which schematically illustrates a coil component 3000 according to a third example embodiment of the present disclosure, is a view corresponding to FIG. 6. FIG. 9 is a view illustrating a cross-section taken along line III-III’ of FIG. 8.

When comparing FIGS. 6 and 7 with FIGS. 8 and 9, respectively, the coil component 3000 according to the third example embodiment of the present disclosure may be different from the coil component 2000 according to the second example embodiment of the present disclosure, in terms of no slit portion being formed in the body, shapes of the connection portions 410 and 510, a cover target of the first insulating layer 610 on the first surface 101 and the second surface 102 of the body 100, and the like.

Therefore, in describing the present example embodiment, only the connection portions 410 and 510, and the first insulating layer 610, which are different from those in the second example embodiment of the present disclosure, are described. With respect to the other elements of the present example embodiment, the description of the second example embodiment of the present disclosure may be applied in the same manner.

Referring to FIGS. 8 and 9, in the coil component 3000 according to the present example embodiment, the lead-out portions 331 and 332 and the external electrodes 400 and 500 may be interconnected on the first surface 101 and the second surface 102 of the body 100.

The first connection portion 410 may be connected to the first lead-out portion 331 on the first surface 101 of the body 100, and may extend to the sixth surface 106 of the body 100. In addition, the second connection portion 510 may be connected to the second lead-out portion 332 on the second surface 102 of the body 100, and may extend to the sixth surface 106 of the body 100.

The first metal layer 11 and the second metal layer 12 may be sequentially disposed on the connection portions 410 and 510 of the sixth surface 106 of the body 100 through a plating process in the same manner as those in the second example embodiment.

In the coil component 3000 according to the present example embodiment, outermost surfaces of the external electrodes 400 and 500 may be formed, with respect to the thickness direction T, further inwards by a predetermined depth D3 than an outermost surface of the first insulating layer 610 formed on the sixth surface 106 of the body 100. For example, opposing ends of the first external electrode 400 and opposing ends of the second external electrode 500 may be embedded with respect to an outer surface of the coil component such as an outer surface of the first insulating layer 610.

This may be a structure formed through an etching process performed on lower surfaces of the connection portions 410 and 510, and accordingly, a surface roughness SR3 of a surface of the first metal layer 11 in contact with the connection portions 410 and 510 may be formed to be different from (or higher than) a surface roughness of each of outermost surfaces of the external electrode 400 and 500.

Through such an electrode-embedded structure, a volume occupied by a magnetic material of the body 100 in a coil component with the same size may be increased, thereby having an effect of improving an effective volume. In addition, compared to an electrode protrusion type structure, adhesive strength when mounted may also be improved.

In the coil component 3000 according to the present example embodiment, the first insulating layer 610 may be disposed to cover the first and second connection portions 410 and 510 on the first and second surfaces 101 and 102 of the body 100, respectively, and thus the external electrodes 400 and 500 may be formed to be exposed only to the sixth surface 106 that is a mounting surface.

In the coil component 3000 according to the present example embodiment, areas of the connection portions 410 and 510 respectively connected to the lead-out portions 331 and 332 may be increased, thereby improving an Rdc characteristic.

### Fourth and Fifth Example Embodiments

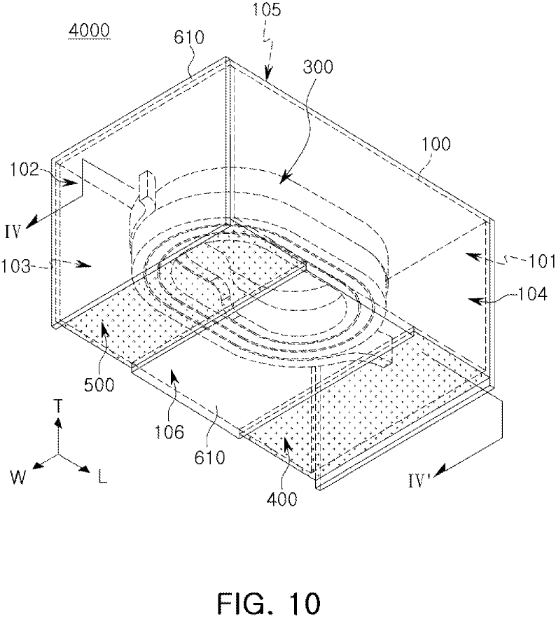

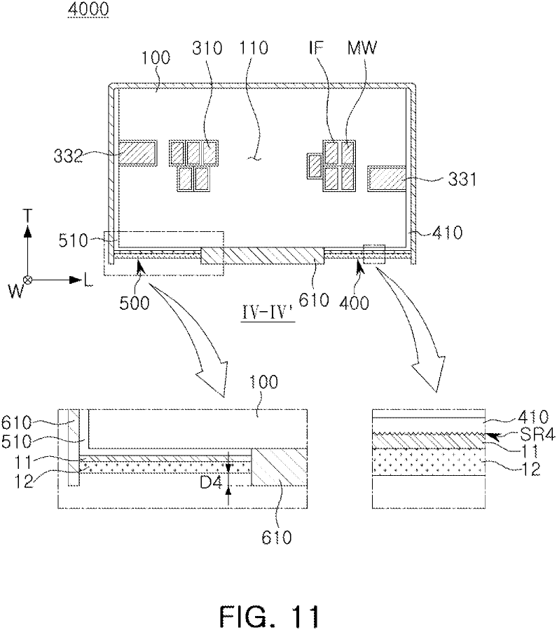

FIG. 10, which schematically illustrates a coil component 4000 according to a fourth example embodiment of the present disclosure, is a view corresponding to FIG. 8. FIG. 11 is a view illustrating a cross-section taken along line IV-IV′ of FIG. 10.

When comparing FIGS. 8 and 9 with FIGS. 10 and 11, respectively, the coil component 4000 according to the fourth example embodiment of the present disclosure may be different from the coil component 3000 according to the third example embodiment of the present disclosure, in terms of the substrate 200 that is not included, a structure of the coil portion 300, and the like.

Therefore, in describing the present example embodiment, only the coil portion 300, which is different from that in the third example embodiment of the present disclosure, is described. With respect to the other elements of the present example embodiment, the description of the third example embodiment of the present disclosure may be applied in the same manner.

Referring to FIGS. 10 and 11, the coil portion 300 may be a wound coil formed by spirally winding a wire including a metal wire MW such as a copper wire or the like, and an insulating film IF covering a surface of the metal wire MW.

The coil portion 300 may include a winding portion 310 having at least one turn formed with respect to the core 110, and the lead-out portions 331 and 332 respectively extending from opposite ends of the winding portion 310 to be respectively exposed to the first surface 101 and the second surface 102 of the body 100.

The first lead-out portion 331 may extend from one end of the winding portion 310 to be exposed to the first surface 101 of the body 100, and the second lead-out portion 332 may extend from another end of the winding portion 310 to be exposed to the second surface 102 of the body 100.

The winding portion 310 may be formed by spirally winding the aforementioned wire. Referring to FIG. 11, in the coil component 3000 according to the present example embodiment may have a shape in which a surface of each turn of the winding portion 310 is coated with the insulating film IF, on a cross-section in a longitudinal direction L-thickness direction T. The winding portion 310 may include at least one layer. Each layer of the winding portion 310 may be formed to have a planar spiral shape, and thus may have at least one number of turns.

The lead-out portions 331 and 332 may be integrally formed with the winding portion 310. For example, the winding portion 310 may be formed by winding the aforementioned wire, and regions of the wire extending from the winding portion 310 may be used as the lead-out portions 331 and 332.

The metal wire MW may be formed of a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof, but the present embodiment is not limited thereto.

The insulating layer IF may include an insulating material such as enamel, parylene, epoxy, polyimide, or the like. The insulating layer IF may be formed of two or more layers. As a non-limiting example, the insulating film IF may include a coating layer in contact with the metal wire MW, and a fusion layer formed on the coating layer. The fusion layer may be coupled to a fusion layer of the metal wire MW included in turns adjacent to each other by heat and pressure after the metal wire MW that is a wire is wound to have a coil shape. When the metal wire MW including the insulating film IF having such a structure is wound, fusion layers of a plurality of turns of the winding portion 310 may be fused to each other and integrated.

FIGS. 10 and 11 illustrate that the coil portion 300 according to the present example embodiment is an alpha-shaped winding, but the scope of the present example embodiment is not limited thereto, and it should be noted that an edge-wise winding is included in the present example embodiment.

Referring to FIG. 11, the external electrodes 400 and 500 of the coil component 4000 according to the present example embodiment may form a step difference D4 with the first insulating layer 610 on the sixth surface 106 of the body 100 in the same manner as the coil component 3000 according to the third example embodiment. For example, opposing ends of the first external electrode 400 and opposing ends of the second external electrode 500 may be embedded with respect to an outer surface of the coil component such as an outer surface of the first insulating layer 610. In addition, according to an etching process performed on lower surfaces of the connection portions 410 and 510, a surface roughness SR4 of a surface between the connection portions 410 and 510 and the first metal layer 11 may be formed to be different from (or higher than) a surface roughness of each of outermost surfaces of the external electrodes 400 and 500.

Through such an electrode-embedded structure, a volume occupied by a magnetic material of the body 100 in a coil component with the same size may be increased, thereby having an effect of improving an effective volume. In addition, compared to an electrode protrusion type structure, adhesive strength when mounted may also be improved.

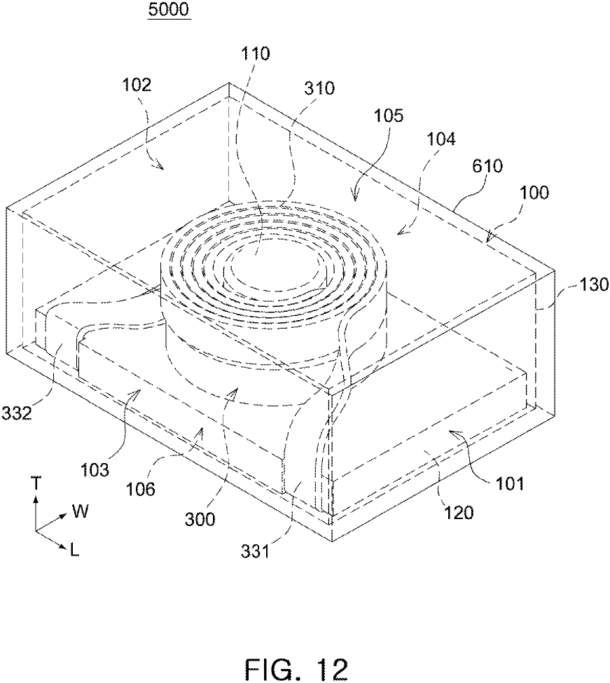

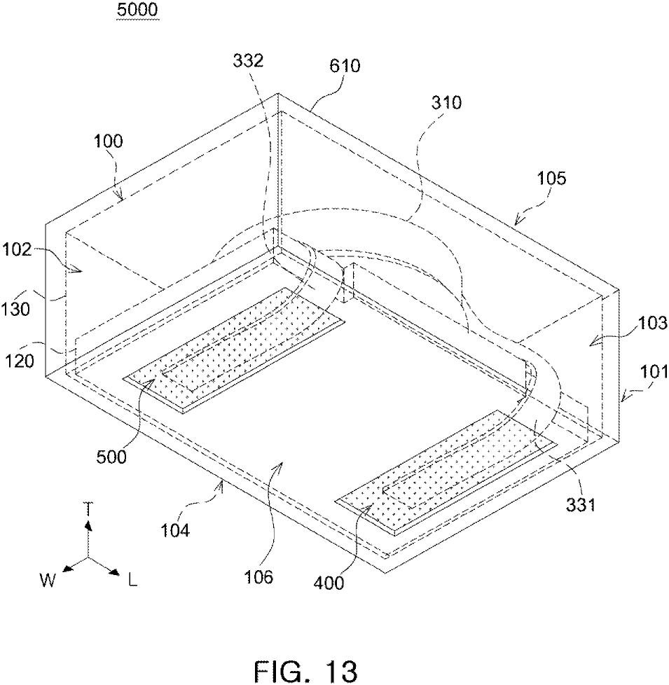

FIG. 12 is a perspective view schematically illustrating a coil component according to a fifth example embodiment of the present disclosure. FIG. 13 is a bottom perspective view of FIG. 12.

The coil component 5000 according to the present example embodiment may be different from the coil component 4000 according to the fourth example embodiment of the present disclosure, in terms of the body 100 including a molded portion 120 and a cover portion 130, opposite ends of the coil portion 300 that are led out to the sixth surface 106 of the body 100 to be spaced apart from each other, shapes of the electrodes 400 and 500, and the like.

Therefore, in describing the present example embodiment, only the body 100, the coil portion 300, and the external electrodes 400 and 500, which are different from those in the fourth example embodiment of the present disclosure, are described. With respect to the other elements of the present example embodiment, the description of the fourth example embodiment of the present disclosure may be applied in the same manner.

Referring to FIG. 12, the body 100 of the coil component 5000 according to the present example embodiment may include the molded portion 120 and the cover portion 130. The cover portion 130 may be disposed on an upper portion of the molded portion 120 to surround all surfaces of the molded portion 120 excluding a lower surface of the molded portion 120. Accordingly, the first to fifth surfaces 101, 102, 103, 104, and 105 of the body 100 may be formed by the cover portion 130, and the sixth surface 106 of the body 100 may be formed by the molded portion 120 and the cover portion 130.

The molded portion 120 may have one surface and the other surface opposing each other. The molded portion 120 may support the coil portion 300 disposed on the other surface. The molded portion 120 may include the core 110, and the core 110 may be disposed on a central portion of the other surface of the molded portion 120 to have a form passing through the coil portion 300. The one surface of the molded portion 120 may be included in a portion of the sixth surface 106 of the body 100.

The cover portion 130 may cover the molded portion 120 and the coil portion 300 to be described below. The cover portion 130 may be disposed on the molded portion 120 and the coil portion 300, and then pressed to be coupled to the molded portion 120.

At least one of the molded portion 120 and the cover portion 130 may include a magnetic material. In the present example embodiment, both the molded portion 120 and the cover portion 130 may include the magnetic material. For example, the molded portion 120 may be formed by filling the magnetic material in a mold for forming the molded portion 120. For another example, the molded portion 120 may be formed by filling the mold with a composite material including the magnetic material and an insulating resin. A molding process of applying high temperature and high pressure to the magnetic material or the composite material in the mold may be additionally performed, but the present embodiment is not limited thereto. The molded portion 120 and the core 110 may be integrally formed by the mold, and thus no boundary may be formed therebetween. The cover portion 130 may be formed by disposing a magnetic composite sheet including the magnetic material dispersed in the insulating resin on the molded portion 120 and the coil portion 300, and then heating and pressing the magnetic composite sheet.

Referring to FIG. 13, the lead-out portions 331 and 332 connected to opposite ends of the winding portion 310 may be disposed along the molded portion 110 to be exposed to the sixth surface 106 of the body 100.

Accordingly, the external electrodes 400 and 500 may be disposed on the sixth surface 106 of the body 100 to be directly connected to the lead-out portions 331 and 332, and the connection portions 410 and 510 may be omitted. In addition, areas of the external electrodes 400 and 500 disposed on the sixth surface 106 of the body 100 may be reduced.

As a result, the coil component 5000 according to the present example embodiment may have an effect of increasing an effective volume to correspond to reduced volumes of the external electrodes 400 and 500 based on a coil component with the same size, compared to the coil component 4000 according to the fourth example embodiment.

While example embodiments have been shown and described above, it will be apparent to those skilled in the art that modifications and variations could be made without departing from the scope of the present disclosure as defined by the appended claims.

What is claimed is:

1. A coil component comprising:
a body having one surface and the other surface opposing each other in one direction;
a coil portion disposed in the body, the coil portion including a lead-out portion; and
an external electrode disposed on the one surface of the body to be connected to the lead-out portion,
wherein an outermost surface of the external electrode is disposed of inwards than the one surface of the body.

2. The coil component of claim 1, wherein
the body has a plurality of side surfaces connecting the one surface and the other surface, and
the external electrode is spaced apart from the plurality of side surfaces.

3. The coil component of claim 1, wherein the external electrode includes a first metal layer connected to the lead-out portion, and a second metal layer covering the first metal layer.

4. The coil component of claim 3, wherein a surface roughness of a surface of the lead-out portion in contact with the first metal layer is different from a surface roughness of the outermost surface of the external electrode.

5. The coil component of claim 4, wherein the surface roughness of the surface of the lead-out portion in contact with the first metal layer is greater than the surface roughness of the outermost surface of the external electrode.

6. The coil component of claim 3, wherein
the first metal layer includes nickel (Ni), and
the second metal layer includes tin (Sn).

7. The coil component of claim 1, wherein
the coil portion further includes a coil pattern having a plurality of turns, and
a central axis of each turn of the coil pattern is perpendicular to the one direction.

8. The coil component of claim 1, further comprising:
a substrate disposed in the body to support the coil portion,
wherein the coil portion further includes:
first and second coil patterns respectively disposed on one surface and the other surface of the substrate; and
a via passing through the substrate to connect inner ends of the first and second coil patterns to each other.

9. The coil component of claim 8, wherein the lead-out portion includes:
a lead-out pattern disposed on the one surface of the substrate to be connected to the coil pattern; and
a sub-lead-out pattern disposed on the other surface of the substrate to be spaced apart from the coil pattern.

10. The coil component of claim 9, further comprising:
a sub-via passing through the substrate to connect the lead-out pattern and the sub-lead-out pattern to each other.

11. A coil component comprising:
a body having one surface and the other surface opposing each other in one direction, and a plurality of side surfaces connecting the one surface and the other surface;
a coil portion disposed in the body, the coil portion including a lead-out portion extending to one side surface of the body;
an external electrode disposed on the one side surface of the body to be connected to the lead-out portion, the external electrode covering at least a portion of the one surface of the body; and
a first insulating layer disposed on the one surface of the body,
wherein a surface of the external electrode in contact with the one surface of the body is coplanar with a surface of the first insulating layer in contact with the one surface of the body, and
an outermost surface of the external electrode is disposed of inwards than an outermost surface of the first insulating layer.

12. The coil component of claim 11, wherein the external electrode includes:
a connection portion connected to the lead-out portion to extend to the one surface of the body;
a first metal layer covering the connection portion on the one surface of the body; and
a second metal layer covering the first metal layer.

13. The coil component of claim 12, wherein a surface roughness of a surface of the first metal layer in contact with the connection portion is different from a surface roughness of the outermost surface of the external electrode.

14. The coil component of claim 13, wherein the surface roughness of the surface of the first metal layer in contact with the connection portion is greater than the surface roughness of the outermost surface of the external electrode.

15. The coil component of claim 12, wherein
the connection portion includes copper (Cu),
the first metal layer includes nickel (Ni), and
the second metal layer includes tin (Sn).

16. The coil component of claim 11, wherein
the coil portion further includes a coil pattern having a plurality of turns, and
a central axis of each turn of the coil pattern is parallel to the one direction.

17. The coil component of claim 11, wherein the first insulating layer covers the external electrode on the one side surface of the body.

18. The coil component of claim 11, further comprising:
a slit portion disposed at an edge portion having one side surface in contact with the one surface of the body, the lead-out portion extending from the slit portion,
wherein the external electrode extends to the slit portion to be connected to the lead-out portion.

19. The coil component of claim 18, further comprising:
a second insulating layer covering the external electrode in the slit portion.

20. The coil component of claim 19, wherein the first insulating layer covers the second insulating layer in the slit portion.

21. The coil component of claim 11, further comprising:
a substrate disposed in the body to support the coil portion,
wherein the coil portion further includes:
first and second coil patterns respectively disposed on opposite surfaces of the substrate; and
a via passing through the substrate to connect inner ends of the first and second coil patterns to each other.

22. The coil component of claim 11, wherein the coil portion includes a wound coil.

23. A coil component comprising:
a body;
a coil portion disposed in the body and including a lead-out portion; and
an external electrode connected to the lead-out portion,
wherein opposing ends of the external electrode are embedded with respect to an outer surface of the coil component.

24. The coil component of claim 23, wherein
the body has a plurality of surfaces, and
the external electrode is disposed on or in only one of the plurality of surfaces.

25. The coil component of claim 23, wherein a surface roughness of a surface of the lead-out portion in contact with the external electrode is different from a surface roughness of an outermost surface of the external electrode.

26. The coil component of claim 25, wherein the surface roughness of the surface of the lead-out portion in contact with the external electrode is greater than the surface roughness of the outermost surface of the external electrode.

27. The coil component of claim 23, wherein a magnetic material and a resin of the body provide the outer surface of the coil component.

28. The coil component of claim 23, further comprising an insulating layer disposed on the body,
wherein the insulating layer provides the outer surface of the coil component.
